(19) United States
(12) Patent Application Publication
(10) Pub. No.: US 2021/0163013 A1
(43) Pub. Date: Jun. 3, 2021

(54) PERIPHERAL-INFORMATION DETERMINING APPARATUS

(71) Applicant: Mitsubishi Electric Corporation, Tokyo (JP)

(72) Inventors: Yoshinori UENO, Tokyo (JP); Naohiko OBATA, Tokyo (JP); Mitsuo SHIMOTANI, Tokyo (JP); Yoshitaka NAKAMURA, Tokyo (JP); Tadashi MIYAHARA, Tokyo (JP)

(73) Assignee: Mitsubishi Electric Corporation, Tokyo (JP)

(21) Appl. No.: 16/325,101

(22) PCT Filed: Oct. 25, 2016
(86) PCT No.: PCT/JP2016/081519

§ 371 Date: Feb. 12, 2019

(51) Int. Cl. B60W 40/04; B60W 60/00; B60Q 5/00; B60Q 1/50; G06K 9/00

(52) U.S. Cl. CPC B60W 40/04; B60W 60/0017; B60Q 5/005; B60Q 1/50; B60W 2556/10; G06K 9/00302; B60W 2554/4045; B60W 2554/4029; G06K 9/00791

(57) ABSTRACT

In a peripheral-information determining apparatus, a peripheral-information acquiring unit acquires peripheral information indicating circumstances around a subject vehicle, from a peripheral-information detector that detects the circumstances around the subject vehicle. An intention estimating unit estimates, from person movement information, an intention of a person around the subject vehicle or an instruction of an indicator around the subject vehicle. The person movement information is included in the peripheral information, and is a piece of information that indicates a movement of the person, or a movement of the indicator that imitates a person's movement. A controller controls a travel controller or an outward-notification apparatus on the basis of the peripheral information and an estimated result that is obtained from the intention estimating unit. The travel controller controls the traveling of the subject vehicle. The outward-notification apparatus notifies information to the outside of the subject vehicle.

### TECHNICAL FIELD

The present invention relates to a peripheral-information determining apparatus and a method for determining peripheral information that are used to control autonomous vehicle driving.

### BACKGROUND ART

An autonomous driving technique has been recently developed in which a vehicle is made to autonomously drive (i.e., autonomously travel) in accordance with peripheral circumstances. Further, Patent Document 1 proposes an in-vehicle apparatus that estimates a driver's intention from a driver's driving operation upon detecting a pedestrian, so that the pedestrian is notified of the estimated driver's intention.

### PRIOR ART DOCUMENT

### Patent Document

Patent Document 1: Japanese Patent Application Laid-Open No. 2005-332297

### SUMMARY

### Problem to be Solved by the Invention

Communication between a vehicle under autonomous traveling and a pedestrian is important to practically apply autonomous vehicle driving on a road where pedestrians walk around. For instance, although a vehicle under autonomous driving detects a pedestrian standing near a crosswalk and then stops before the crosswalk, the pedestrian does not intend to cross the crosswalk in some cases. In these cases, the vehicle would automatically restart traveling if the vehicle recognized the intention of the pedestrian. However, a conventional vehicle, which does not have a means for recognizing such a pedestrian's intention, keeps stopping before the crosswalk, thus possibly causing traffic congestion.

In the technique of Patent Document 1, the vehicle can convey a driver's intention to the pedestrian, but cannot recognize a pedestrian's intention.

To solve this problem, it is an object of the present invention to provide a peripheral-information determining apparatus and a method for determining peripheral information that are used for vehicle control reflecting an intention of a person around a vehicle.

### Means to Solve the Problem

A peripheral-information determining apparatus according to the present invention includes the following: a peripheral-information acquiring unit that acquires peripheral information indicating a circumstance around a subject vehicle, from a peripheral-information detector that detects the circumstance around the subject vehicle; an intention estimating unit that estimates an intention of a person who is around the subject vehicle, or an instruction of an indicator that is around the subject vehicle, from person movement information that is included in the peripheral information and is a piece of information indicating a movement of the person, or a movement of the indicator that imitates a person's movement; and a controller that controls a traveling controller or an outward-notification apparatus on the basis of the peripheral information and an estimated result that is obtained from the intention estimating unit. The traveling controller controls the traveling of the subject vehicle. The outward-notification apparatus notifies information to the outside of the subject vehicle.

### Effects of the Invention

In the present invention, the intention estimating unit estimates the intention of the person around the subject vehicle. In addition, the controller controls the traveling controller or outward-notification apparatus of the subject vehicle on the basis of the estimated result. Such a configuration enables the subject vehicle to travel or to make a notification with the intention of the person reflected.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a diagram illustrating the configuration of a vehicle control system according to a first embodiment.

FIG. 2 is a table showing examples of an intention-estimation performing place, and examples of a target person.

FIG. 3 is a diagram illustrating an example of the hardware configuration of a peripheral-information determining apparatus.

FIG. 4 is a diagram illustrating an example of the hardware configuration of the peripheral-information determining apparatus.

FIG. 5 is a flowchart showing the operation of the peripheral-information determining apparatus according to the first embodiment.

FIG. 6 is a diagram for describing how the peripheral-information determining apparatus operates when a subject vehicle has approached a site before a crosswalk.

FIG. 7 is a diagram for describing how the peripheral-information determining apparatus operates when the subject vehicle has approached the site before the crosswalk.

FIG. 8 is a diagram for describing how the peripheral-information determining apparatus operates when the subject vehicle has approached the site before the crosswalk.

FIG. 9 is a diagram for describing how the peripheral-information determining apparatus operates when the subject vehicle has approached the site before the crosswalk.

FIG. 10 is a diagram illustrating an example of how to make a notification to a pedestrian.

FIG. 11 is a diagram illustrating an example of how to make a notification to the pedestrian.

FIG. 12 is a flowchart showing the operation of a peripheral-information determining apparatus according to a second embodiment.

FIG. 13 is a diagram illustrating the configuration of a vehicle control system according to a third embodiment.

FIG. 14 is a diagram illustrating the configuration of a vehicle control system according to a fourth embodiment.

### DESCRIPTION OF EMBODIMENT(S)

### First Embodiment

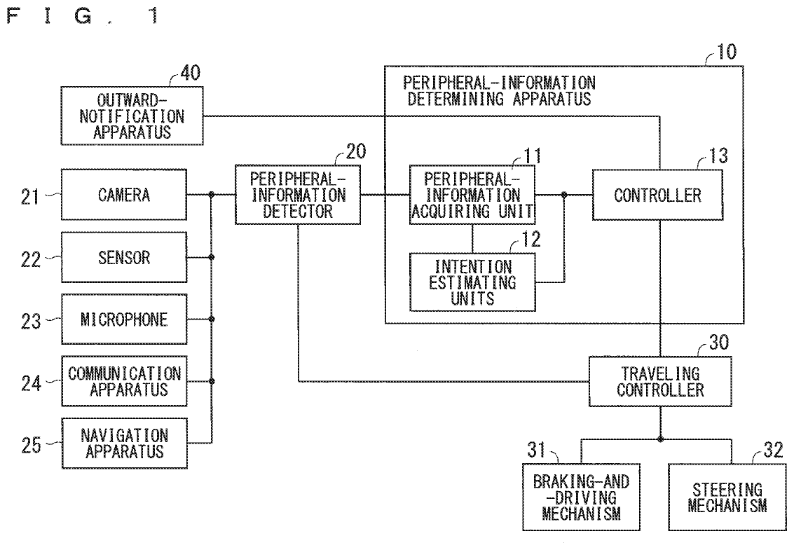

FIG. 1 is a diagram illustrating the configuration of a vehicle control system according to a first embodiment. This vehicle control system includes the following: a peripheral-information determining apparatus 10 that performs autonomous vehicle driving; and a peripheral-information detector 20, a traveling controller 30, and an outward-notification apparatus 40 that are connected to the peripheral-information determining apparatus 10. A vehicle that is equipped with the peripheral-information determination system is hereinafter referred to as a “subject vehicle”. A vehicle other than the subject vehicle is hereinafter referred to as a “non-subject vehicle”.

The peripheral-information detector 20 detects “peripheral information” that is a piece of information indicating circumstances around the subject vehicle, from signals that are output from sensing apparatuses included in the subject vehicle, such as a camera 21, a sensor 22, a microphone 23, a communication apparatus 24, and a navigation apparatus 25. The peripheral information, detected by the peripheral-information detector 20, is transmitted to the peripheral-information determining apparatus 10 and the traveling controller 30.

The traveling controller 30 controls the traveling of the subject vehicle by controlling a braking-and-driving mechanism 31 and a steering mechanism 32 that are included in the subject vehicle, on the basis of the peripheral information, received from the peripheral-information detector 20, and of a control signal that is output from the peripheral-information determining apparatus 10. The braking-and-driving mechanism 31 is a mechanism for controlling the travel speed of the subject vehicle and switching between forward and backward movements of the subject vehicle. The braking-and-driving mechanism 31 includes an accelerator, a brake, a shift lever, and other things. The steering mechanism 32 is a mechanism for turning the direction of travel of the subject vehicle to right or left. The steering mechanism 32 includes a steering wheel and other things.

As illustrated in FIG. 1, the peripheral-information determining apparatus 10 includes a peripheral-information acquiring unit 11, an intention estimating unit 12, and a controller 13. The peripheral-information acquiring unit 11 acquires the peripheral information from the peripheral-information detector 20. The peripheral information includes information pieces, such as a picture around the subject vehicle that is captured by the camera 21, an obstacle (including a non-subject vehicle and a pedestrian, and other things) around the subject vehicle that is detected by the sensor 22, a sound around the subject vehicle that is obtained by the microphone 23 (preferably, by a directional microphone), an information piece obtained by the communication apparatus 24 through communication, and a subject vehicle position on a map, a map information piece around the subject vehicle and a route where the subject vehicle is to travel that are identified by the navigation apparatus 25.

Examples of the information piece obtained by the communication apparatus 24 include the following: a piece of positional information about a non-subject vehicle around the subject vehicle, the positional information being obtained through vehicle-to-vehicle communication; a piece of positional information about a pedestrian that is obtained through communication with a portable terminal carried by the pedestrian (e.g., a watch-like communication terminal); and a piece of traffic information (e.g., a piece of information about a construction section, or a piece of information about a travel restriction) obtained through vehicle-to-roadside-infrastructure communication. Further, a pedestrian may operate his/her portable terminal to positively transmit information about whether the pedestrian is going to cross a crosswalk to the communication apparatus 24 included in a nearby vehicle.

A “pedestrian” in the Description is not limited to a walking person. A “pedestrian” herein is used in a broad sense ranging, for instance, from a person who is pushing a baby buggy to a person who is riding a wheelchair or a bicycle.

The intention estimating unit 12 estimates an intention of a person around the subject vehicle when the subject vehicle has approached a specific place satisfying a predetermined condition (“an intention-estimation performing place”). The intention-estimation performing place is a place where communication is required between the subject vehicle and a person outside the subject vehicle (e.g., a pedestrian, or a traffic controller who directs traffic). A site before a crosswalk, a site before a lane restriction section, an entrance to a parking lot of a destination (or of a stopping point on the way to the destination), the inside of the parking lot, an exit of the parking lot, a site before an intersection without traffic lights, and other sites are previously defined as intention-estimation performing places.

The intention estimating unit 12 can determine whether the subject vehicle has approached the intention-estimation performing place from information pieces, such as a picture around the subject vehicle that is captured by the camera 21, the distance to an obstacle around the subject vehicle that is obtained by the sensor 22, the position of the subject vehicle on a map that is obtained from the navigation apparatus 25. Whether the subject vehicle has approached the intention-estimation performing place needs to be determined based on whether the distance between the subject vehicle and the intention-estimation performing place has reached a predetermined threshold or less.

Upon approach of the subject vehicle to the intention-estimation performing place, the intention estimating unit 12 checks whether a person whose intention is to be estimated (i.e., “a target person”) is near the subject vehicle, on the basis of the peripheral information obtained by the peripheral-information acquiring unit 11. Upon detection of the target person, the intention estimating unit 12 extracts, from the peripheral information, “person movement information” indicating a movement of the target person, and estimates an intention of the target person on the basis of the extracted person movement information. Information extracted as the person movement information is any information piece from which an intention of the target person can be estimated. Examples of such an information piece include a picture captured by the camera 21 and from which the posture, gesture, sight line direction, facial expression, and other things of the target person can be recognized, and an audio data piece obtained through the microphone 23 and from which the voice of the target person can be recognized. Further, when the target person operates his/her portable terminal to input information on whether the target person is going to cross a crosswalk, and then transmit the information to the communication apparatus 24 included in a nearby vehicle, the intention estimating unit 12 obtains the operation content of his/her portable terminal as the person movement information.

Here, there are two kinds of intention of the target person. One is an intention indicating an action of the target person, such as “crossing a street” or “standing still without crossing a street”. The other is an intention indicating a request from the target person to the subject vehicle, such as a “request for a vehicle to stop”, or a “request for a vehicle to go”. The intention estimating unit 12 preferably estimates both kinds. Nevertheless, the intention “crossing a street” is also an intention indicating that the target person “wants a vehicle to stop”, and that the intention “standing still without crossing a street” is also an intention indicating that the target person “wants a vehicle to go”. Hence, the intention estimating unit 12 may estimate one of the two kinds.

The controller 13 controls the peripheral-information determining apparatus 10 overall, and controls autonomous driving of the subject vehicle by transmitting and receiving a piece of control information and a control command to and from the traveling controller 30. Moreover, the controller 13 can control the outward-notification apparatus 40 to notify information (including a warning and an alarm) to the outside of the subject vehicle.

In the present embodiment in particular, the controller 13 reflects the intention of the target person estimated by the intention estimating unit 12 to its control, when the traveling controller 30 controls the subject vehicle to autonomously drive for passing through the intention-estimation performing place.

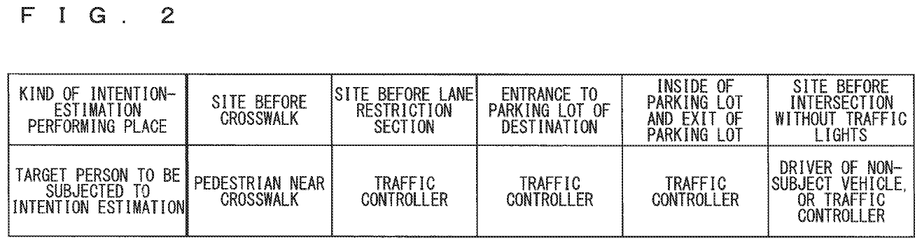

Here, the target person to be subjected to intention estimation changes depending on kinds of intention-estimation performing place. FIG. 2 is a table showing examples of the relationship between the kinds of intention-estimation performing place and the target person. As shown in FIG. 2, when the subject vehicle has approached a site before a crosswalk, the intention estimating unit 12 regards a pedestrian around the crosswalk as the target person to be subjected to intention estimation. Further, the intention estimating unit 12 regards a traffic controller who is directing traffic as the target person to be subjected to intention estimation, when the subject vehicle has approached a site before a lane restriction section, when the subject vehicle has approached an entrance to a parking lot of a destination, when the subject vehicle is traveling in the parking lot, and when the subject vehicle has approached an exit of the parking lot. A pedestrian in the parking lot may be regarded as another target person to be subjected to intention estimation. Still further, when the subject vehicle has approached a site before an intersection without traffic lights, the intention estimating unit 12 regards the driver of a non-subject vehicle who is about to enter the intersection or a traffic controller who is directing traffic as the target person to be subjected to intention estimation.

In some cases, instead of a traffic controller, an indicator that imitates a person's movement (e.g., a person-like signboard automatically blinking a lamp in a construction site) is placed in a lane restriction section, a parking lot, an intersection without traffic lights, and other locations. In these cases, the indicator may be regarded as the target person. The intention estimating unit 12, in this case, regards the shape, movement, and output sound of the indicator as the posture, gesture, and voice of a person, and estimates an indicator's instruction. That is, the intention estimating unit 12 extracts, as the person movement information, information indicating the shape and movement of the indicator, and estimates the indicator's instruction from the person movement information.

Upon estimation of the target-person's intention in the intention estimating unit 12, the controller 13 controls the outward-notification apparatus 40 to provide the target person with a notification in accordance with an estimated intention result. The outward-notification apparatus 40 makes a notification to the outside of the subject vehicle. The outward-notification apparatus 40 is, for instance, the horn or headlights of the subject vehicle. Alternatively, the outward-notification apparatus 40 may be, for instance, a speaker that outputs a sound to the outside of the subject vehicle, a projector that projects an image onto a road, or a communication apparatus that transmits information to a portable terminal (e.g., a watch-like communication terminal) carried by the target person.

It is noted that the components (i.e., the peripheral-information acquiring unit 11, the intention estimating unit 12, and the controller 13) of the peripheral-information determining apparatus 10, in part or in whole, may be included in the peripheral-information detector 20. It is also noted that the navigation apparatus 25 and the peripheral-information acquiring unit 11 may directly communicate with each other without the peripheral-information detector 20 interposed therebetween.

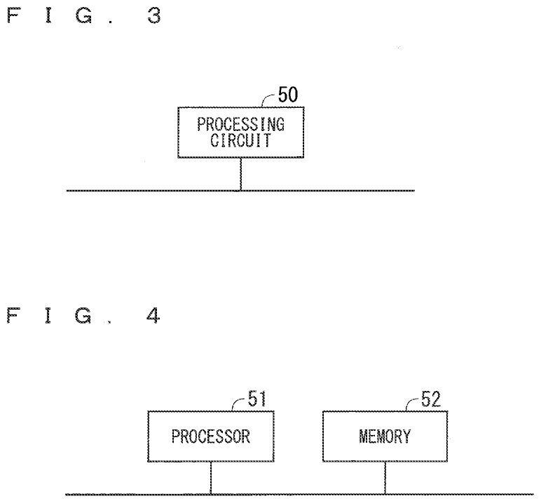

FIGS. 3 and 4 are each a diagram illustrating an example of the hardware configuration of the peripheral-information determining apparatus 10. The individual components (i.e., the peripheral-information acquiring unit 11, the intention estimating unit 12, and the controller 13) of the peripheral-information determining apparatus 10 illustrated in FIG. 1 are implemented by, for instance, a processing circuit 50 illustrated in FIG. 3. That is, the processing circuit 50 includes the following: the peripheral-information acquiring unit 11 that acquires peripheral information from the peripheral-information detector 20; the intention estimating unit 12 that estimates an intention of a person who is around a subject vehicle or an instruction of an indicator that is around the subject vehicle, from person movement information that is included in the peripheral information and is a piece of information indicating a movement of the person, or a movement of the indicator that imitates a person's movement; and the controller that controls the traveling controller 30 or the outward-notification apparatus 40 on the basis of the peripheral information and an estimated result obtained from the intention estimating unit. The processing circuit 50 may be dedicated hardware. Alternatively, the processing circuit 50 may be a processor (e.g., a central processing unit, a central processing device, a processing device, a calculator, a microprocessor, a microcomputer, or a digital signal processor) that executes a program stored in a memory. The intention estimating unit 12 does not necessarily need to be on board the subject vehicle. The intention estimating unit 12 may be implemented as a cloud service connected to the peripheral-information determining apparatus 10 via a communication apparatus.

For dedicated hardware being the processing circuit 50, examples of the processing circuit 50 include a single circuit, a complex circuit, a programmed processor, a parallel-programmed processor, an ASIC, an FPGA, and a combination thereof. The functions of the individual components of the peripheral-information determining apparatus 10 may be implemented by a plurality of processing circuits, or may be, all together, implemented by a single processing circuit.

FIG. 4 is a diagram illustrating the hardware configuration of the peripheral-information determining apparatus 10 when the processing circuit 50 is configured using a processor. In this case, the functions of the individual components of the peripheral-information determining apparatus 10 are implemented in combination with software and other things (software, firmware, or software and firmware). The software and other things are written as a program and stored in a memory 52. A processor 51, which is the processing circuit 50, implements the function of each component by reading and then executing the program stored in the memory. That is, the peripheral-information determining apparatus 10 includes the memory 52 to store a program which, when executed by the processing circuit 50, performs the following processes: acquiring person movement information that is a piece of information indicating a movement of a person who is around a subject vehicle, or a movement of an indicator that is around the subject vehicle and imitates a person's movement; estimating an intention of the person or an instruction of the indicator from the person movement information; and controlling the traveling controller 30 or the outward-notification apparatus 40 on the basis of the estimated intention of the person or the estimated instruction of the indicator. The travel controller 30 controls the travelling of the subject vehicle. The outward-notification apparatus 40 notifies information to the outside of the subject vehicle. In other words, this program is for a computer to execute the procedure or method of the operation of each component included in the peripheral-information determining apparatus 10.

Here, examples of the memory 52 includes a non-volatile or volatile semiconductor memory (e.g., a random access memory or RAM for short, a read only memory or ROM for short, a flash memory, an erasable programmable read only memory or EPROM for short, an electrically erasable programmable read only memory or EEPROM for short), a hard disk drive (HDD), a magnetic disc, a flexible disc, an optical disc, a compact disc, a mini disc, a digital versatile disc (DVD), and drivers thereof. Alternatively, the memory 52 may be any kind of storing medium that will be used in the future.

The foregoing has described that the function of each component of the peripheral-information determining apparatus 10 is implemented by one of hardware, software, and other things. Part of the components of the peripheral-information determining apparatus 10 may be implemented by dedicated hardware; and different part of the components, by software and other things. For instance, the functions of part of the components can be implemented by the processing circuit 50, which is dedicated hardware; moreover, the functions of different part of the components can be implemented by the processing circuit 50 (i.e., the processor 51) reading and then executing the program stored in the memory 52.

As described above, the peripheral-information determining apparatus 10 can implement the aforementioned individual functions using hardware, software, and other things, or using a combination thereof.

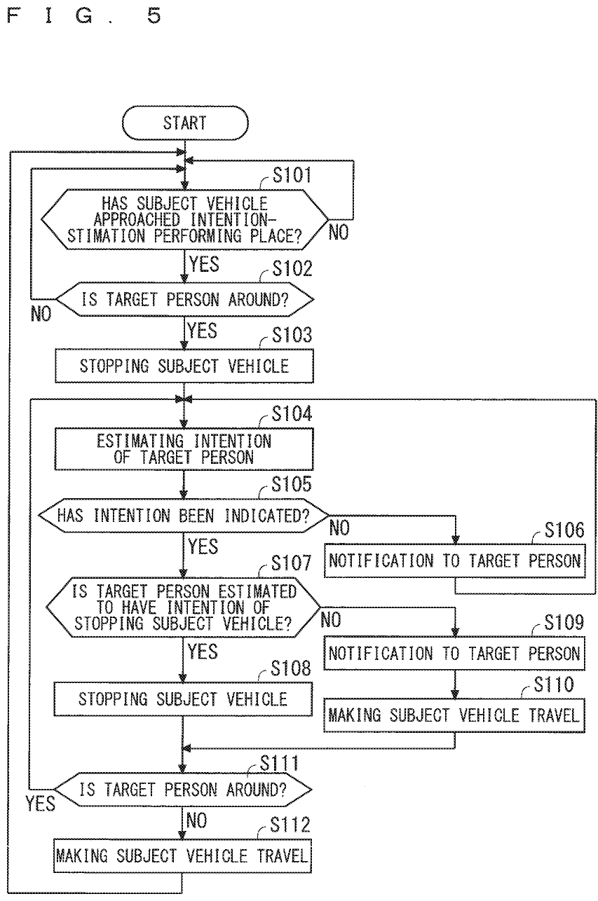

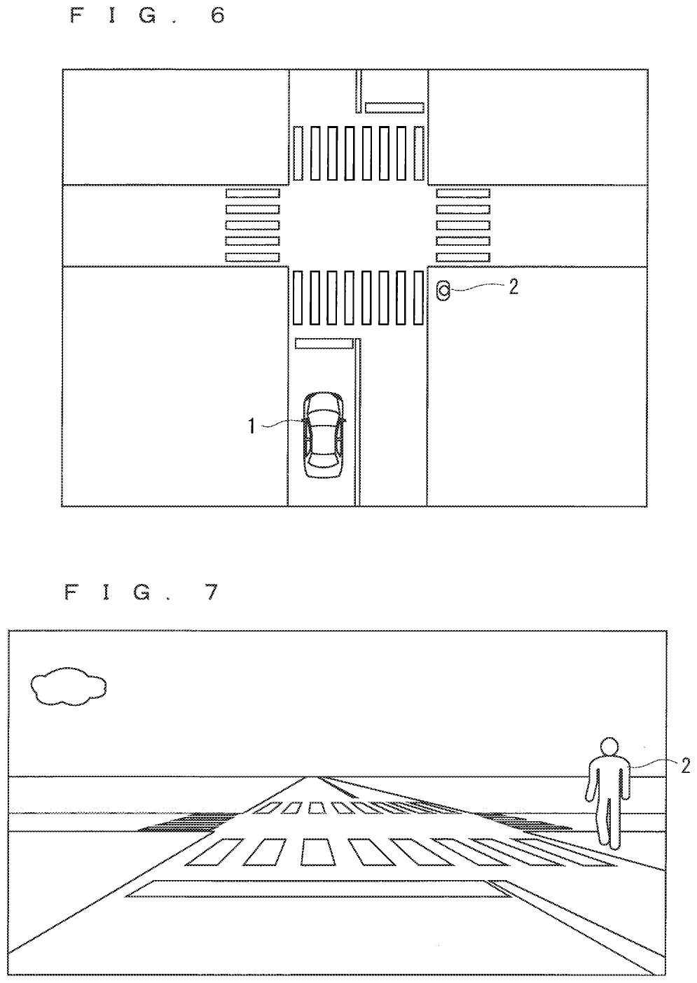

FIG. 5 is a flowchart showing the operation of the peripheral-information determining apparatus 10. FIGS. 6 to 11 are diagrams each illustrating a specific example of how the peripheral-information determining apparatus 10 operates when the subject vehicle has approached a site before a crosswalk. The following describes the operation of the peripheral-information determining apparatus 10 with reference to FIGS. 5 to 11. The process flow in FIG. 5 is executed while the traveling controller 30 is controlling the subject vehicle to autonomously drive.

Upon start of the autonomous driving of the subject vehicle, the intention estimating unit 12 of the peripheral-information determining apparatus 10 checks whether the subject vehicle has approached an intention-estimation performing place, on the basis of peripheral information acquired by the peripheral-information acquiring unit 11 (step S101). The intention estimating unit 12 repeatedly executes step S101 as long as the intention estimating unit 12 determines that the subject vehicle has not yet approached the intention-estimation performing place (i.e., if NO in step S101).

Upon determining that the subject vehicle has approached the intention-estimation performing place (i.e., if YES in step S101), the intention estimating unit 12 checks whether a target person to be subjected to intention estimation is around the subject vehicle, on the basis of the peripheral information acquired by the peripheral-information acquiring unit 11 (step S102). As illustrated in FIG. 6 for instance, when a subject vehicle 1 has approached a site before a crosswalk, which is the intention-estimation performing place, the intention estimating unit 12 regards a pedestrian 2 near the crosswalk as the target person to be subjected to intention estimation.

If no target person is around the subject vehicle (i.e., if NO in step S102), the process flow returns to step S101. When a state where no target person appears is kept, the subject vehicle passes through the intention-estimation performing place during the repetition of steps S101 and S102.

If the target person is around the subject vehicle (i.e., if YES in step S102), the controller 13 controls the traveling controller 30 to stop the subject vehicle (step S103). In the example in FIG. 6, the subject vehicle 1 stops at a stop line before the crosswalk.

Subsequently, the intention estimating unit 12 estimates an intention of the target person on the basis of person movement information extracted from the peripheral information (step S104). At this time, if the target person indicates no intention (i.e., if NO in step S105), the controller 13 controls the outward-notification apparatus 40 to convey an intention that the subject vehicle is going to stop to the target person, and to also make a notification for asking the target person to indicate his/her intention (step S106). The process flow then returns to step S104. Examples of how to make the notification in step S106 include sounding a horn and lighting up headlights.

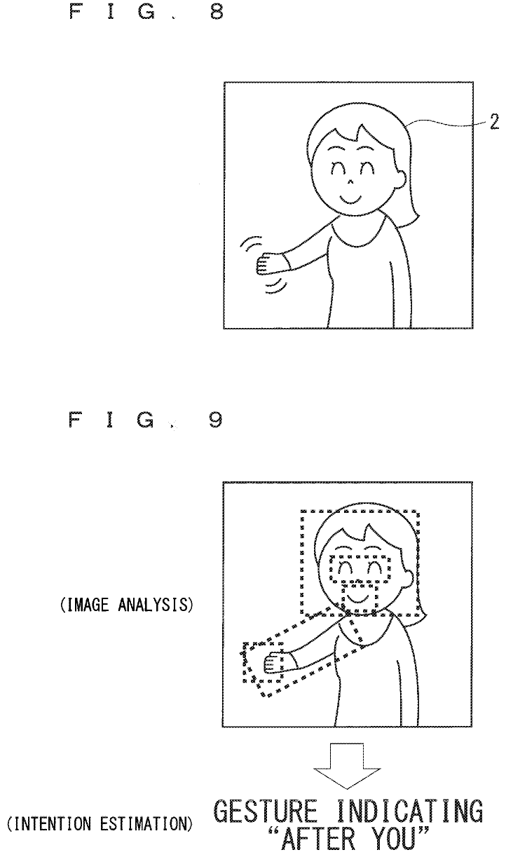

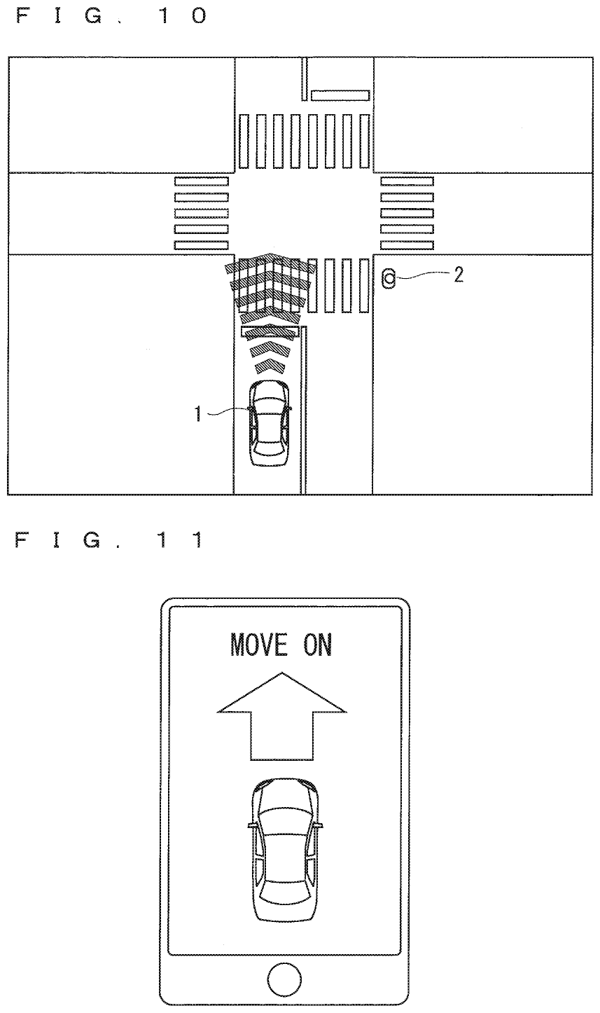

In the example in FIG. 6, let a picture as illustrated in FIG. 7, which is the peripheral information, be obtained from the camera 21 of the subject vehicle 1. Then, the intention estimating unit 12 extracts, as the person movement information, the picture of the pedestrian 2 as illustrated in FIG. 8 from the obtained picture in FIG. 7. As illustrated in FIG. 9, the intention estimating unit 12 then performs image analysis on the picture of the pedestrian 2, thus estimating an intention of the pedestrian 2 from the posture of the pedestrian 2, the gesture of the pedestrian 2 that is identified from his/her hand movement, the sight line direction and facial expression of the pedestrian 2, and other things. As illustrated in FIG. 8 for instance, when the pedestrian 2 are stretching out his/her hand while looking at the subject vehicle with a smile, the intention estimating unit 12 determines that the pedestrian 2 is making a gesture indicating “after you”, thus determining that the pedestrian 2 is attempting to allow the subject vehicle to go without stop.

Further, when the pedestrian 2 is showing a posture of raising his/her hand, or when the pedestrian 2 has actually started crossing the crosswalk, for instance, the intention estimating unit 12 estimates that the pedestrian 2 has an intention of stopping the subject vehicle and crossing the crosswalk.

In some cases, different countries have different correspondences between a kind of person's posture or gesture and an intention indicated by the posture or gesture. As such, the correspondences between the kind of person's posture or gesture and the intention, with regard to a plurality of countries are stored in the peripheral-information determining apparatus 10, so that a user can change country settings. Alternatively, the peripheral-information determining apparatus 10 may determine the country of a current location on the basis of positional information of the subject vehicle, and may automatically change the correspondences between the kind of person's posture or gesture and the intention in accordance with the countries.

If the intention estimating unit 12 determines that the target person has an intention indicating that the target person wants to stop the subject vehicle (i.e., if YES in step S107), the controller 13 controls the traveling controller 30 to keep the subject vehicle stop (step S108). Conversely, if the intention estimating unit 12 estimates that the target person has an intention indicating that the target person wants the subject vehicle to go (i.e., if NO in step S107), the controller 13 controls the outward-notification apparatus 40 to provide the target person with a notification of the travelling of the subject vehicle (step S109), and then starts the traveling of the subject vehicle (step S110).

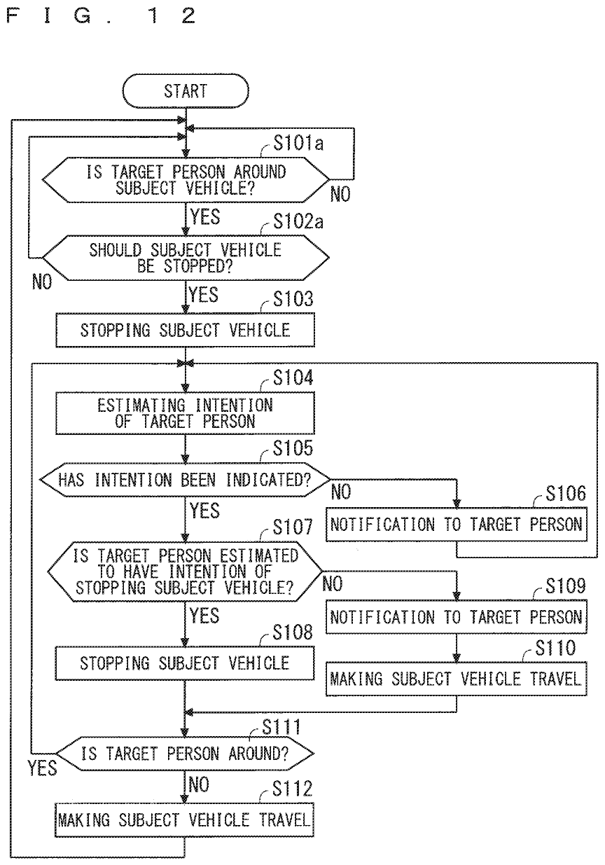

The notification in step S109 is made using a horn or headlights, which is similar to the notification in step S106. Nevertheless, examples of an effective way to make the notification in step S109 include projecting an image that indicates the direction of travel onto a road or indicating the direction of travel using a lighting pattern of a headlight, as illustrated in FIG. 10, and transmitting, for display, an image that indicates the subject vehicle is going to move on to a portable terminal (e.g., a watch-like portable terminal) carried by the pedestrian 2, as illustrated in FIG. 11.

After step S108 or step S110, the intention estimating unit 12 again checks whether the target person is around the subject vehicle (step S111). If the target person is still around the subject vehicle (i.e., if YES in step S111), the process flow returns to step S104. Through a process loop of steps S104 to S111, the intention estimating unit 12 continuously estimates an intention of the target person, while the traveling controller 30 is controlling the subject vehicle to travel on the basis of the estimated intention of the target person. Such continuous intention estimation, which is performed on the target person by the intention estimating unit 12, can suitably deal with a sudden change in the intention of the target person or an incorrect result of previously performed intention estimation, if any. Reference is made to the example in FIG. 8. Let the pedestrian 2 start crossing the crosswalk after the subject vehicle 1 starts moving on, without indicating an intention of stopping the subject vehicle 1 (an intention of crossing the crosswalk). Then, a determination of YES is made in step S107 in the next process loop; accordingly the subject vehicle 1 stops in step S108.

Subsequently, a determination of NO is made in step S111 when the subject vehicle 1 has passed through the intention-estimation performing place, or when the target person has gone (e.g., when the pedestrian 2 has crossed the crosswalk in the example in FIG. 8). In this case, the subject vehicle is made to travel (step S112); then the process flow returns to step S101.

As described above, the peripheral-information determining apparatus 10 in the present embodiment includes the intention estimating unit 12 that estimates the intention of the person around the subject vehicle, and the controller 13 that controls the traveling of the subject vehicle on the basis of the result of the estimation. Such a configuration enables the subject vehicle to autonomously drive with the intention of the person reflected.

The foregoing has described a specific example where the intention-estimation performing place is a site before the crosswalk. As illustrated in FIG. 2, the present invention is applied also to an instance where the intention-estimation performing place is, for instance, a site before a lane restrict section, an entrance to a parking lot of a destination, the inside of the parking lot, an exit of the parking lot, or a site before an intersection without traffic lights.

For instance, let a traffic controller be around the subject vehicle when the subject vehicle has approached a site before a lane restriction section. Then, the stopping and moving on of the subject vehicle are switched in accordance with gestures (e.g., hand flag signals) of the traffic controller who is directing traffic.

Further, when the subject vehicle has approached an entrance to a parking lot of a destination, the inside of the parking lot, or an exit of the parking lot, the subject vehicle autonomously travels in accordance with gestures of a traffic controller in the parking lot. In the above example, the intention estimating unit 12 estimates only an intention indicating whether the target person wants to stop the subject vehicle. When a traffic controller, who is the target person, is making a gesture indicating a direction in which the traffic controller wants to move the subject vehicle, the intention estimating unit 12 may estimate this direction, thus controlling the direction of travel of the subject vehicle.

Furthermore, when the subject vehicle has approached a site before an intersection without traffic lights, the stopping and traveling of the subject vehicle are switched in accordance with a gesture of the driver of a non-subject vehicle who is about to enter the intersection, or a gesture of a traffic controller. This switching avoids an instance where the subject vehicle and the non-subject vehicle yield the right-of-way to each other, thus getting stuck.

### Second Embodiment

The first embodiment has described that upon approach of the subject vehicle to the intention-estimation performing places shown in FIG. 2, the intention estimating unit 12 estimates the intention of the target person; moreover, the controller 13 controls the traveling controller 30 or the outward-notification apparatus 40 in accordance with the result of the estimation. The intention estimating unit 12 may perform intention estimation on the target person in any place other than the intention-estimation performing places shown in FIG. 2. The second embodiment describes that the intention estimating unit 12 performs intention estimation on the target person, not only when the subject vehicle has approached these intention-estimation performing places, but also, for instance, while the subject vehicle is traveling on an ordinary road.

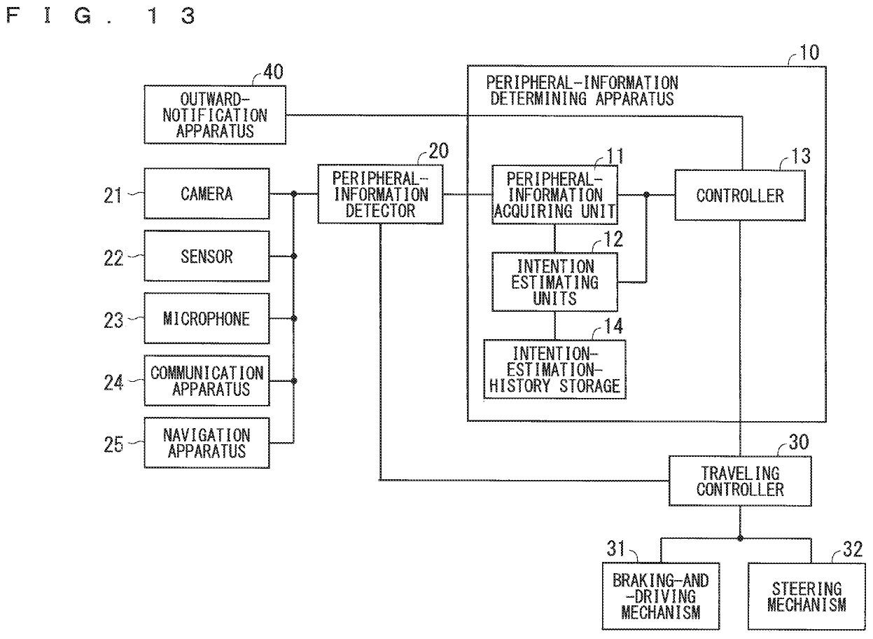

FIG. 12 is a flowchart showing the operation of a peripheral-information determining apparatus according to the second embodiment. The process flow in FIG. 12 has steps S101a and S102a instead of steps S101 and S102 of the process flow in FIG. 5.

During autonomous driving of the subject vehicle, the intention estimating unit 12 of the peripheral-information determining apparatus 10 checks whether a target person is around the subject vehicle on the basis of peripheral information, which is obtained by the peripheral-information acquiring unit 11 (step S101a). Although every pedestrian may be regarded as the target person in the second embodiment, the intention estimating unit 12 less needs to estimate an intention of a pedestrian who is away from a roadway. Hence, only a pedestrian on a roadway ahead of the subject vehicle or a pedestrian facing this roadway, for instance, may be regarded as the target person.

If no target person is around the subject vehicle (i.e., if NO in step S101a), the process flow repeatedly executes step S101a.

Upon appearance of a target person around the subject vehicle (i.e., if YES in step S101a), the intention estimating unit 12 checks, on the basis of the peripheral information from the peripheral-information acquiring unit 11, whether the intention estimating unit 12 is under a condition where the subject vehicle should be stopped (step S102a). The condition where the subject vehicle should be stopped is considered to be a condition where the subject vehicle, if continuing to travel, might come into contact with a pedestrian. Examples of such a condition include an instance where a pedestrian, who is the target person, is on the course of the subject vehicle, and an instance where the pedestrian is approaching the course of the subject vehicle.

If the intention estimating unit 12 is under the condition where the subject vehicle should be stopped (i.e., if YES in step S102a), the process flow proceeds to step S103. The process flow after step S103, which is the same as that in FIG. 5, will not be elaborated upon here.

If the intention estimating unit 12 is not under the condition where the subject vehicle should be stopped (i.e., if NO in step S102a), the process flow returns to S101a. As such, unless the intention estimating unit 12, even though having identified the appearance of the target person, is under the condition where the subject vehicle should be stopped, steps S101a and S102a are merely repeated, and the subject vehicle continues to travel.

The peripheral-information determining apparatus 10 in the second embodiment performs intention estimation on the target person everywhere, which is performed by the intention estimating unit 12, and controls the traveling controller 30 and the outward-notification apparatus 40 everywhere on the basis of the result of the estimation. Such a configuration enables the traveling controller 30 and the outward-notification apparatus 40 to be controlled with a pedestrian's intention reflected even when, for instance, the pedestrian is about to cross a road having no crosswalk.

### Third Embodiment

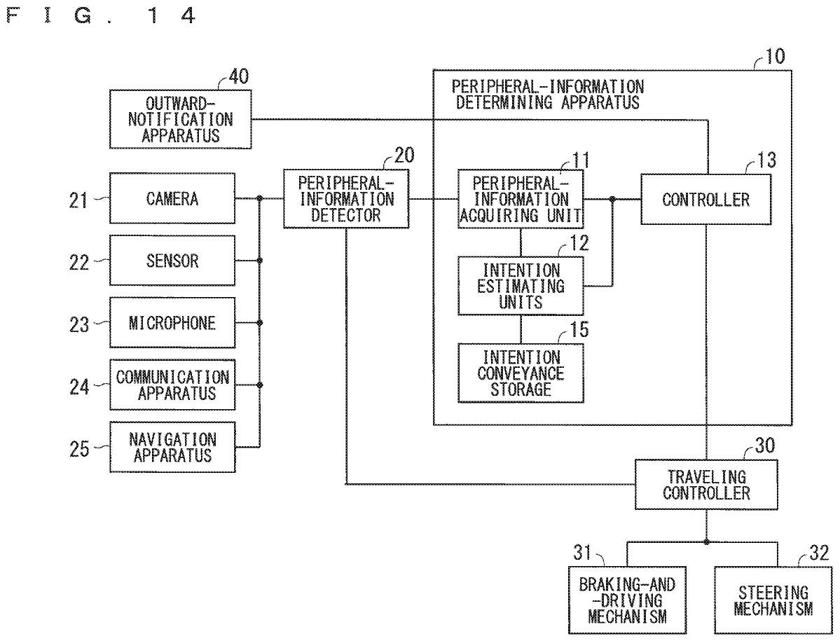

FIG. 13 is a diagram illustrating the configuration of a vehicle control system according to a third embodiment. The peripheral-information determining apparatus 10 in this vehicle control system includes an intention-estimation-history storage 14 in addition to the configuration in FIG. 1. The intention-estimation-history storage 14 is a storage medium that stores a history of person movement information, which is input to the intention estimating unit 12, and a history of the result of person-intention estimation performed by the intention estimating unit 12 (intention estimation history). It is noted that the intention-estimation-history storage 14 may be separate hardware that is external to the peripheral-information determining apparatus 10. Further, the intention-estimation-history storage 14 does not necessarily need to be on board the subject vehicle. The intention-estimation-history storage 14 may be implemented as a cloud service connected to the peripheral-information determining apparatus 10 via a communication apparatus.

The storing of the intention estimation history in the intention-estimation-history storage 14 enables, for instance, whether the intention estimation of a target person, performed by the intention estimating unit 12, is correct to be verified at a later time.

The intention estimating unit 12 may have a learning function of learning, on the basis of information stored in the intention-estimation-history storage 14, the correspondence between a person's movement and an intention indicated by the person's movement. For instance, in a process loop of steps S104 to S111 in FIG. 5, when a determination result in step S107 has changed at some point, the intention estimating unit 12 estimates that the target person has made a movement that is different from the result of the intention estimation performed by the intention estimating unit 12, thus concluding that the estimated result obtained from the intention estimating unit 12 is probably incorrect. The intention estimating unit 12 learning such information enhances the accuracy of an estimated result obtained from the intention estimating unit 12.

Furthermore, a configuration where information stored in the intention-estimation-history storage 14 is uploaded to a server managed by the manufacturer of the peripheral-information determining apparatus 10, enables the manufacturer to analyze this information, thus contributing to an improvement in the algorithm for intention estimation performed by the intention estimating unit 12.

### Fourth Embodiment

FIG. 14 is a diagram illustrating the configuration of a vehicle control system according to a fourth embodiment. The peripheral-information determining apparatus 10 in this vehicle control system includes an intention conveyance storage 15 in addition to the configuration in FIG. 1. The intention conveyance storage 15 is a storage medium that stores, as picture and audio information pieces, a human-machine-interface (HMI) sequence of a gesture movement of a target person, a content notified by a subject vehicle using the outward-notification apparatus 40, and other things. The intention conveyance storage 15 may be also separate hardware that is external to the peripheral-information determining apparatus 10. Further, the intention conveyance storage 15 does not necessarily need to be on board the subject vehicle. The intention conveyance storage 15 may be implemented as a cloud service connected to the peripheral-information determining apparatus 10 via a communication apparatus.

The intention conveyance storage 15 can serve as a so-called driving recorder, and can store, for instance, evidence pieces in accident occurrence.

It is noted that in the present invention, the individual embodiments can be freely combined, or can be modified and omitted as appropriate, within the scope of the invention.

While the invention has been shown and described in detail, the foregoing description is in all aspects illustrative and not restrictive. It is therefore understood that numerous modifications and variations can be devised without departing from the scope of the invention.

### EXPLANATION OF REFERENCE SIGNS

10 peripheral-information determining apparatus, 11 peripheral-information acquiring unit, 12 intention estimating unit, 13 controller, 14 intention-estimation-history storage, 15 intention conveyance storage, 20 peripheral-information detector, 21 camera, 22 sensor, 23 microphone, 24 communication apparatus, 25 navigation apparatus, 30 traveling controller, 31 braking-and-driving mechanism, 32 steering mechanism, 40 outward-notification apparatus, 1 subject vehicle, 2 pedestrian

1-16. (canceled)

17. A peripheral-information determining apparatus comprising:
a processor to execute a program; and
a memory to store the program which, when executed by the processor, performs processes of,
acquiring peripheral information indicating a circumstance around a subject vehicle, from a peripheral-information detector configured to detect the circumstance around the subject vehicle,
estimating an intention of a person who is around the subject vehicle, or an instruction of an indicator that is around the subject vehicle, from person movement information that is included in the peripheral information and is a piece of information indicating a movement of the person, or a movement of the indicator that imitates a person's movement, and
controlling a traveling controller or an outward-notification apparatus on the basis of the peripheral information and an estimated result of the intention of the person or the instruction of the indicator, the traveling controller being configured to control traveling of the subject vehicle, the outward-notification apparatus being configured to notify information to an outside of the subject vehicle,
wherein the intention of the person or the instruction of the indicator includes at least one of an intention of the person or an instruction of the indicator corresponding to a content of a sound emitted by the person or the indicator and obtained via a microphone that is on board the subject vehicle, and an intention or an instruction indicating a request from the person or the indicator to the subject vehicle.

18. A peripheral-information determining apparatus comprising:
a processor to execute a program; and
a memory to store the program which, when executed by the processor, performs processes of,
acquiring peripheral information indicating a circumstance around a subject vehicle, from a peripheral-information detector configured to detect the circumstance around the subject vehicle,
estimating an intention of a person who is around the subject vehicle, or an instruction of an indicator that is around the subject vehicle, from person movement information that is included in the peripheral information and is a piece of information indicating a movement of the person, or a movement of the indicator that imitates a person's movement,
controlling a traveling controller or an outward-notification apparatus on the basis of the peripheral information and an estimated result of the intention of the person or the instruction of the indicator, the traveling controller being configured to control traveling of the subject vehicle, the outward-notification apparatus being configured to notify information to an outside of the subject vehicle, and
storing at least one information piece among a history of the person-movement information, a history of the estimated result, the movement of the person or indicator, and a content notified using the outward-notification apparatus.

19. A peripheral-information determining apparatus comprising:
a processor to execute a program; and
a memory to store the program which, when executed by the processor, performs processes of,
acquiring peripheral information indicating a circumstance around a subject vehicle, from a peripheral-information detector configured to detect the circumstance around the subject vehicle,
estimating an intention of a person who is around the subject vehicle, or an instruction of an indicator that is around the subject vehicle, from person movement information that is included in the peripheral information and is a piece of information indicating a movement of the person, or a movement of the indicator that imitates a person's movement, and
controlling a traveling controller to control the subject vehicle to travel in accordance with the intention of the person or the instruction of the indicator, on the basis of the peripheral information and an estimated result of the intention of the person or the instruction of the indicator.

20. A peripheral-information determining apparatus comprising:
a processor to execute a program; and
a memory to store the program which, when executed by the processor, performs processes of,
acquiring peripheral information indicating a circumstance around a subject vehicle, from a peripheral-information detector configured to detect the circumstance around the subject vehicle,
estimating an intention of a person who is around the subject vehicle, or an instruction of an indicator that is around the subject vehicle, from person movement information that is included in the peripheral information and is a piece of information indicating a movement of the person, or a movement of the indicator that imitates a person's movement, and
controlling an outward-notification apparatus to notify a movement of the subject vehicle to an outside of the subject vehicle, on the basis of the peripheral information and an estimated result of the intention of the person or the instruction of the indicator.

21. The peripheral-information determining apparatus according to claim 18, wherein the processor acquires, as the person movement information, at least one information piece among a gesture, a sight line direction, and a facial expression of the person, and a shape and a movement of the indicator captured by a camera that is on board the subject vehicle.

22. The peripheral-information determining apparatus according to claim 19, wherein the processor acquires, as the person movement information, at least one information piece among a gesture, a sight line direction, and a facial expression of the person, and a shape and a movement of the indicator captured by a camera that is on board the subject vehicle.

23. The peripheral-information determining apparatus according to claim 20, wherein the processor acquires, as the person movement information, at least one information piece among a gesture, a sight line direction, and a facial expression of the person, and a shape and a movement of the indicator captured by a camera that is on board the subject vehicle.

24. The peripheral-information determining apparatus according to claim 22, wherein the processor changes, in accordance with countries, a correspondence between a kind of gesture of the person and an intention indicated by the gesture, or a correspondence between the shape or the movement of the indicator and an instruction indicated by the shape or the movement.

25. The peripheral-information determining apparatus according to claim 19, wherein the processor acquires, as the person movement information, a content of person's operation of a portable terminal from the portable terminal carried by the person.

26. The peripheral-information determining apparatus according to claim 18, wherein the intention of the person estimated by the processor includes an intention indicating an action of the person.

27. The peripheral-information determining apparatus according to claim 19, wherein the intention of the person estimated by the processor includes an intention indicating an action of the person.

28. The peripheral-information determining apparatus according to claim 20, wherein the intention of the person estimated by the processor includes an intention indicating an action of the person.

29. The peripheral-information determining apparatus according to claim 27, wherein the intention of the person estimated by the processor includes an intention of whether the person crosses a road.

30. The peripheral-information determining apparatus according to claim 17, wherein the intention of the person or the instruction of the indicator, estimated by the processor, includes an intention or an instruction of whether the person or the indicator wants to stop the subject vehicle.

31. The peripheral-information determining apparatus according to claim 17, wherein the intention of the person or the instruction of the indicator, estimated by the processor, includes an intention or an instruction indicating a direction where the person or the indicator wants to move the subject vehicle.

32. The peripheral-information determining apparatus according to claim 17, wherein the outward-notification apparatus is used to make a notification to the person in accordance with the estimated result.

33. The peripheral-information determining apparatus according to claim 20, wherein the outward-notification apparatus is used to make a notification to the person in accordance with the estimated result.

34. The peripheral-information determining apparatus according to claim 17, wherein the processor continuously estimates the intention of the person or the instruction of the indicator, also while the traveling controller is making the subject vehicle travel on the basis of the estimated intention of the person or the estimated instruction of the indicator.

35. The peripheral-information determining apparatus according to claim 19, wherein the processor continuously estimates the intention of the person or the instruction of the indicator, also while the traveling controller is making the subject vehicle travel on the basis of the estimated intention of the person or the estimated instruction of the indicator.

36. The peripheral-information determining apparatus according to claim 18, wherein the processor has a learning function of learning a correspondence between a person's movement and an intention indicated by the person's movement on the basis of the stored information piece.
